(19) United States
(12) Patent Application Publication
(10) Pub. No.: US 2010/0225588 A1
(43) Pub. Date: Sep. 9, 2010

(54) Methods And Systems For Optical Detection Of Gestures

(75) Inventors: John David Newton, Auckland (NZ); Nigel Devine, The Warren (SG)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: Next Holdings Limited, Auckland (NZ)

(21) Appl. No.: 12/691,088

(22) Filed: Jan. 21, 2010

(30) Foreign Application Priority Data
Jan. 21, 2009 (AU) 2009900205
Mar. 25, 2009 (AU) 2009901286

(51) Int. Cl. G06F 3/02; G06F 3/01

(52) U.S. Cl. 345/168; 345/156

(57) ABSTRACT

A position detection system can comprise a display device, an input device, and an optical assembly positioned adjacent to the display device. The optical assembly can comprise an image sensor configured to detect light in a space between the display device and the input device. One or both of the imaging assembly and the input device can be configured to direct energy into the space between the display device and the input device, with directing energy comprising reflecting energy and/or emitting energy. A processing device can be configured to use the imaging sensor to determine when an object is in the space and/or to determine motion of the object.

### PRIORITY CLAIM

This application claims priority to Australian provisional application AU 2009900205, filed Jan. 21, 2009 and titled “Front of Screen Gesture Detection,” and to Australian provisional application AU 2009901286, filed Mar. 25, 2009 and titled “A Movement Sensitive Input Device,” each of which is incorporated by reference herein in its entirety.

### BACKGROUND

Computers and other electronic devices incorporating a screen typically require some form of user interaction during use. Typically the interaction is performed by utilizing a control means such as a mouse, keyboard, buttons, switches or the like. Recently, touch sensitive screens have been utilized to interact with computers or the like. Examples of such an arrangement can be found in U.S. Pat. No. 6,690,363 (Next Holdings Ltd). For instance, energy beams can be transmitted parallel to a screen surface. An interruption in the energy beams registers a ‘touch’ which may be interpreted to control a computer or the like.

### SUMMARY

Embodiments configured in accordance with one or more aspects of the present subject matter can identify an object's position and/or motion based on interference by the object with a pattern of light in a space above an input device, such as in a space between the input device and a display.

Some such embodiments can allow for recognition of input beyond contact with a screen or hovering over the screen, and thus a computing system can recognize not only basic gestures such as one point contact, two point contact and basic movement gestures or strokes, but also more complex gestures in three-dimensions and utilizing more than one object (e.g., 2-finger gestures). Additionally, because gestures can be recognized near the keyboard or another input device, user inconvenience caused by reaching the touch screen can be avoided.

For example, a position detection system can comprise a display device, an input device, and an optical assembly positioned adjacent to the display device. The optical assembly can comprise an image sensor configured to detect light in a space between the display device and the input device. One or both of the imaging assembly and the input device can be configured to direct energy into the space between the display device and the input device. Directing energy can comprise either or both of reflecting energy and/or emitting energy into the space. A processing device can be configured to use the imaging sensor to determine when an object is in the space and/or to determine motion of the object.

As an example, the imaging assembly can comprise an image sensor and a light source, with the input device comprising a retro-reflective member separate from the display device and in a field of view of the image sensor. For instance, the imaging assembly may be positioned on or near a display and the retro-reflective member included on or in a keyboard. The imaging assembly can project energy from the light source toward the retro-reflective member so that energy is reflected back from the retro-reflected member into the space between the imaging assembly and the keyboard in the absence of interference with at least one of the reflected or projected energy. When interference occurs, a position and/or motion of one or more objects can be recognized. In addition to or instead of a retro-reflective member, an active illumination source such as light-emitting diodes can be positioned at the input device and used to project energy into the space between the imaging assembly and the input device. For example, a keyboard (or other input device) can include one or more diodes or other light sources that are used to emit energy into the space for detection purposes.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a diagram showing an example of determining user input based on interference with light in a space above an input device.

FIG. 2 is a flowchart showing steps in an exemplary method for determining user input based on interference with light.

FIGS. 3A-3B show an example of a computing system configured to determine user input based on interference with light in a space above an input device.

FIG. 4 shows an example of a device configured to reflect light towards one or more sensors by using reflective keys of an input device.

FIG. 5 shows an example of a device configured to reflect light towards one or more sensors by using reflective material visible between keys of an input device.

FIG. 6 shows an example of a device configured to reflect light towards one or more sensors by using reflective material visible through keys of an input device.

FIG. 7 shows an example of a device configured to reflect light towards one or more sensors by providing illumination through and/or between keys of an input device.

FIG. 8 is a block diagram showing illustrative hardware of a computing system configured to determine user input based on interference with light in a space above an input device.

FIG. 9 is a diagram showing a generalized view of use of the visual hull technique in identifying an input gesture

FIG. 10 is a chart showing exemplary triangulation calculations.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

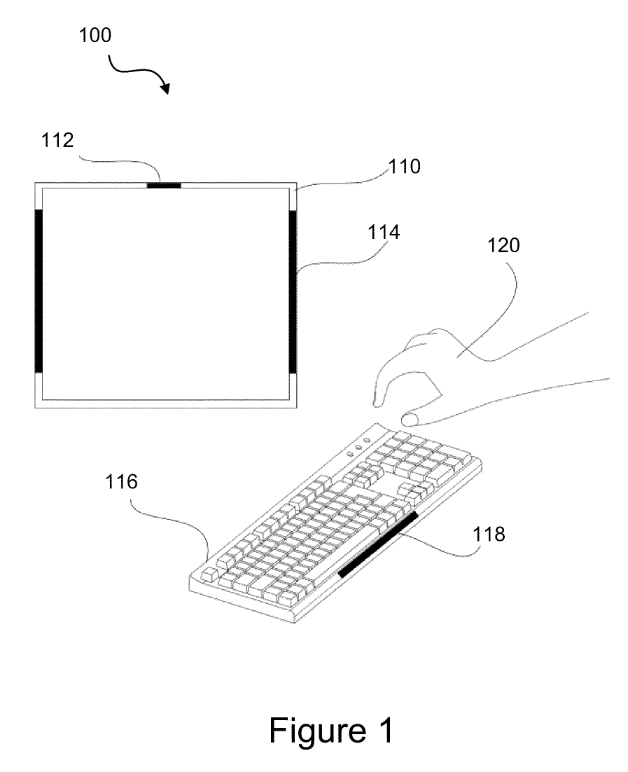

FIG. 1 is a diagram showing an example of determining user input based on interference with light in a space above an input device. In FIG. 1, a position detection system 100 includes a display screen 110. Screen 110 features an optical sensor arrangement 112 and an energy emitter 114 attached thereto. In proximity to the display screen 110 is an input device, in this example a keyboard 116. Energy emitter 114 emits a field of energy above keyboard 116 and the optical sensor arrangement 112 detects the presence of the energy within the field of energy.

As an example, energy emitter 114 may be in the form of a light emitter such as a Light Emitting Diode (LED), light bulb or the like. The energy emitted may be any form, including but not limited to one or more wavelengths of infra red light. Optical sensor arrangement 112 may be in the form of any element capable of sensing energy. Examples include a linear image scanner, area camera, or line scanner.

In this example, a reflective material 118 is comprised in keyboard 116 (and is separate from display screen 110) to reflect the energy emitted from the energy emitter 114 in the direction of the optical sensor arrangement 112. In this example, an emitter 114 is shown on each side of the screen. Depending on the positioning of emitter 114 relative to sensor arrangement 112, a retroreflective material may be used, or another material can be used to reflect light along a suitable trajectory. In another embodiment, one or more energy emitters can be comprised in keyboard 116 for use in addition to or instead of reflective material 118 in directing energy into the space above keyboard 116.

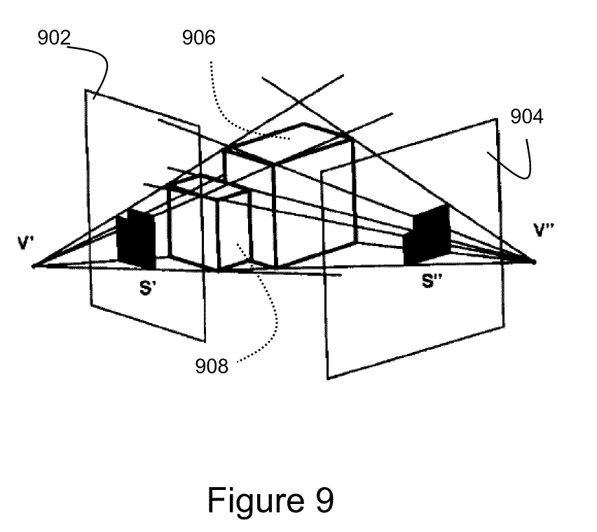

In use, a user may place a hand or hands 120 (and/or another object) above the keyboard 116. Hand(s)/object 120 in the field of energy above the keyboard 116 interferes with one or more portions of the energy from being detected by the optical sensor arrangement 112. The optical sensor arrangement 112 can detect the interference and a computing system can use the change in detected light to determine information about object 120, such as a position or movement of the object. As an example, triangulation can be employed to determine a position of object 120. Shape recognition techniques can be used in identifying the object—exemplary detail is noted later below with FIG. 9.

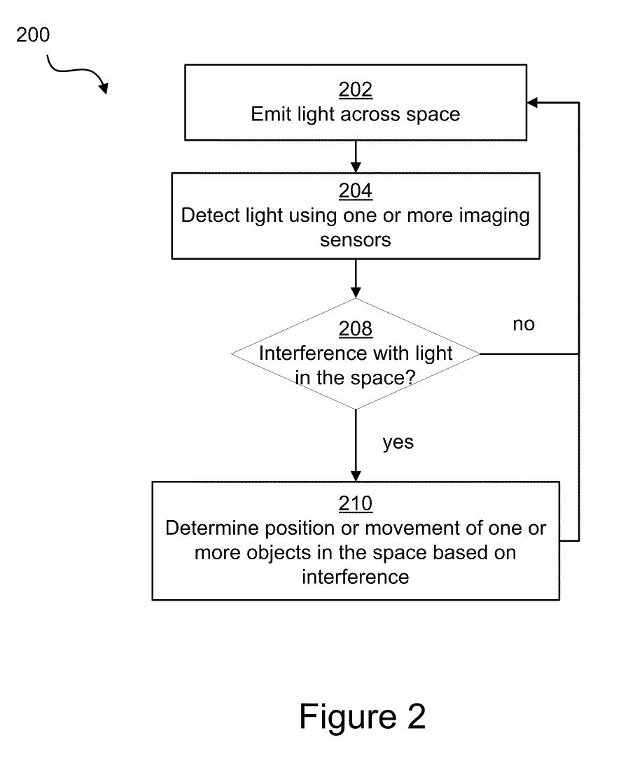

FIG. 2 is a flowchart showing steps in an exemplary method for determining user input based on interference with light. Block 202 represents emitting light into a space above an input device. For example, in one embodiment, this can be achieved by using an emitter positioned adjacent an imaging sensor in a display and emitting light across a space and toward a retro-reflective member, the retro-reflective member comprised in or near an input device of a computing system. As another example, in one embodiment light is emitted from one or more light sources comprised in an input device. The source(s) of the input device may configured similar to those used to provide a keyboard backlighting system, but with appropriate configurations to ensure an adequate amount of energy reaches the space between the keyboard and display for use in detection purposes.

Block 204 represents detecting, using the imaging sensor, light from the space above the input device. For example, the light may comprise light reflected back toward the sensor by a reflective member comprised in the input device and/or may comprise light emitted from a source comprised in the input device. If one or more objects are in the space, the amount and/or distribution of light will be changed as compared to the amount/distribution of light detected when no objects are present.

Block 208 represents determining if one or more objects have interfered with light in the space above the input device. If so, the interference can be used to determining at least one of a position of an object in the space or movement of the object in the space based on interference by the object. Generally speaking, the detected pattern of light can be compared to one or more known patterns of light to determine interference and to identify position and/or motion.

For example, in some embodiments a reflective or retroreflective member is used so that, in the absence of an object in the space, light emitted into the space is returned to the source, with the light source and detector positioned close to one another or even within the same optical assembly. A reduction in light can be detected using the imaging sensor due to interruption of light reflected back toward the sensor by the object. As another example, if one or more active sources are used, then the interruption in light directed into the space and toward the detector can be determined based on a reduction in the detected light.

If interference is detected, then method 200 moves to block 210, which represents determining a position and/or motion of one or more objects in the space based on the interference. For example, an object's position can be inferred based on one or more shadows cast by the object, with the shadows detected as interruptions in retroreflected (or emitted) light. By tracking an object's position over time, input gestures can be identified based on matching an object's trajectory to a pattern of motion associated with a gesture.

As another example, an object's motion may be determined directly from the detected light. For example, movement of the object may be correlated to a particular series of patterns of detected light (e.g., a shadow moving left-to-right correlates to left-to-right motion, etc.) and then used to determine an input.

Any number or type of input gestures can be supported. For instance, when a gesture is detected, a processor can compare the detected gesture to a database of pre-defined gestures. If the gesture is matched, a corresponding command can be passed to the computing device. In this manner, a user may operate a computing device by movement of their hand or hands above the keyboard.

For instance, returning to FIG. 1, a user may lift his hands 120 from typing on the keyboard 116 to perform a gesture. As an example, movement of the hand in a predetermined direction may translate to a command for a vertical or horizontal scroll. Movement by particular fingers on the hand may translate to a command corresponding to a mouse click.

As a further example, it is possible to control movement of a cursor on a screen within a computer program. If the user lifts his fingers from the keyboard, the layer of energy is at least partially obstructed. The user may then move their fingers in any direction, with the optical sensor arrangement detecting the movement of the fingers based upon varying levels of energy being received and passing information relating to the movement to suitable algorithms that move a cursor on a screen in response to movement of the user's fingers.

In a similar fashion it is possible to emulate left and right mouse button clicks by moving fingers up and down above the keyboard. Upon review of the present disclosure, one of skill in the art may be capable of envisioning other input gestures, and so the examples herein are not intended to be limiting.

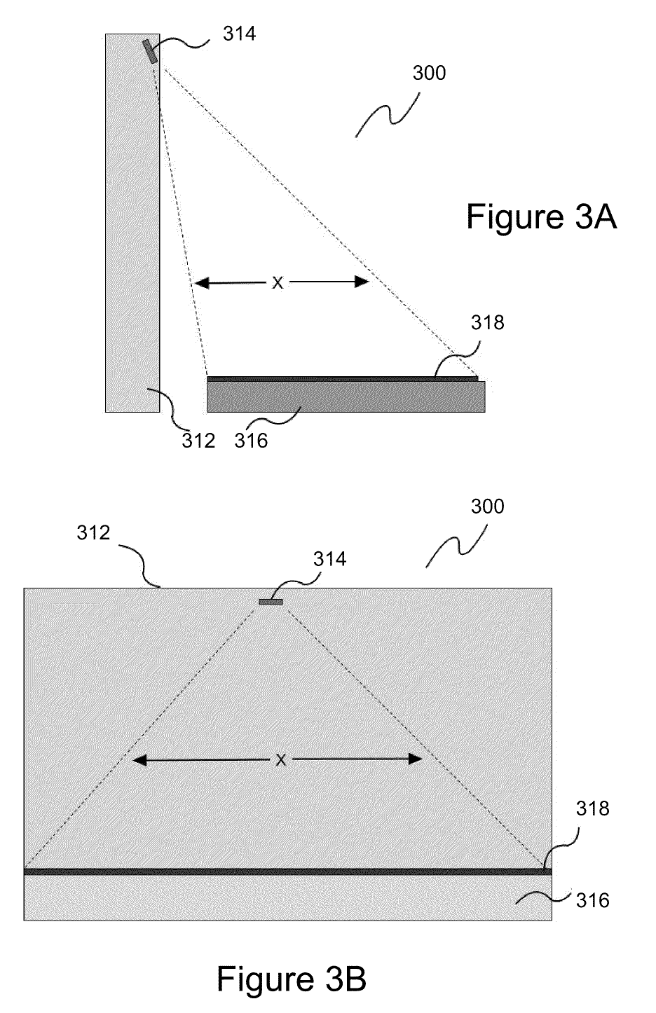

FIGS. 3A-3B show an example of a computing system 300 configured to determine user input based on interference with light in a space above an input device. In this example, a display screen 312 is used along with an image sensor 314, keyboard 316 and retro-reflective member 318. The image sensor 314 is located towards the vertical top of the screen 312 and is angled away from the screen 312 towards the keyboard 316. The retro-reflective member 318 is located on top of the keyboard 316. Although screen 312 and keyboard 316 are shown separately in this example, they may be hinged in some embodiments (e.g., a notebook computer, flip phone, etc.).

Any suitable image sensor 314 can be used. In one embodiment, sensor 314 is included in an optical assembly comprising a linear image sensor with wide angled lens and at least 2 infrared Light Emitting Diodes (LED). The linear image sensor 314 can provide a 512 pixel line scan, with the wide angled lens providing 95 degree viewing and the infrared LEDs having 850 nm wavelength with wide illuminating angle. As another example, an area sensor/camera could be used.

The optical assembly including image sensor 314 emits energy through the LEDs towards the keyboard 316 and retro-reflective member 318 such that the retro-reflective member 318 reflects the energy back towards the image sensor 134. The field of energy transmitted and received is demonstrated by numeral X in FIGS. 3A-3B.

Preferably in some embodiments, the image sensor 314 is connected to an analogue to digital device such as a Digital Signal Processor, hereafter referred to as a DSP (not shown) and the DSP is connected to a computer, preferably by a Universal Serial Bus connection (not shown).

In use, the image sensor 314 is connected to the DSP which samples the image sensor 314 and processes the received information in real time or near real time. The optical assembly projects energy towards the retro-reflective member 318 and receives at least some of that reflected energy back. Any interruption in the reflection of that energy, such as by a hand or other object moving through field X, will result in an analogue signal variance on the image sensor 314. The signal variance may be processed by the Digital Signal Processor which then passes that information to a computer, which can then determine the nature and location of the interruption to perform an action on the computer.

By way of example, a user may move their hand horizontally within field X. Image sensor 314 detects this movement by the absence of reflected energy from the retro-reflective member 318 and passes the information to a computer through a DSP. The computer may then interpret this movement as, for example, horizontal scrolling of a document being viewed on the computer.

In some embodiments, up to two concurrent movements through field X may be sensed by image sensor 314. However, more movements may be detected by making modifications to the image sensor 314 such as increasing the quantity of linear image sensors located therein. Additionally, although the optical assembly including image sensor 314 is located towards the vertical top of the screen 312 in this example, the optical assembly may be placed at any location around the screen 312 so as to illuminate a field anywhere in front of the screen 312. It is possible to mount the optical assembly within a bezel or casing around the screen 312 so as to enhance the aesthetics of the screen 312.

The retro-reflective member 318 can contain micro canted prisms which direct light or energy back in the direction it originated from. The retro-reflective member 318 may be placed on any surface so as to reflect light back towards the image sensor 314, it is described here as being attached to a keyboard 316 by way of example only. In other embodiments, the retro-reflective member 318 could be placed upon another input device, or even could be placed on a table or other flat surface, with position detection used in place of keyboard or other input.

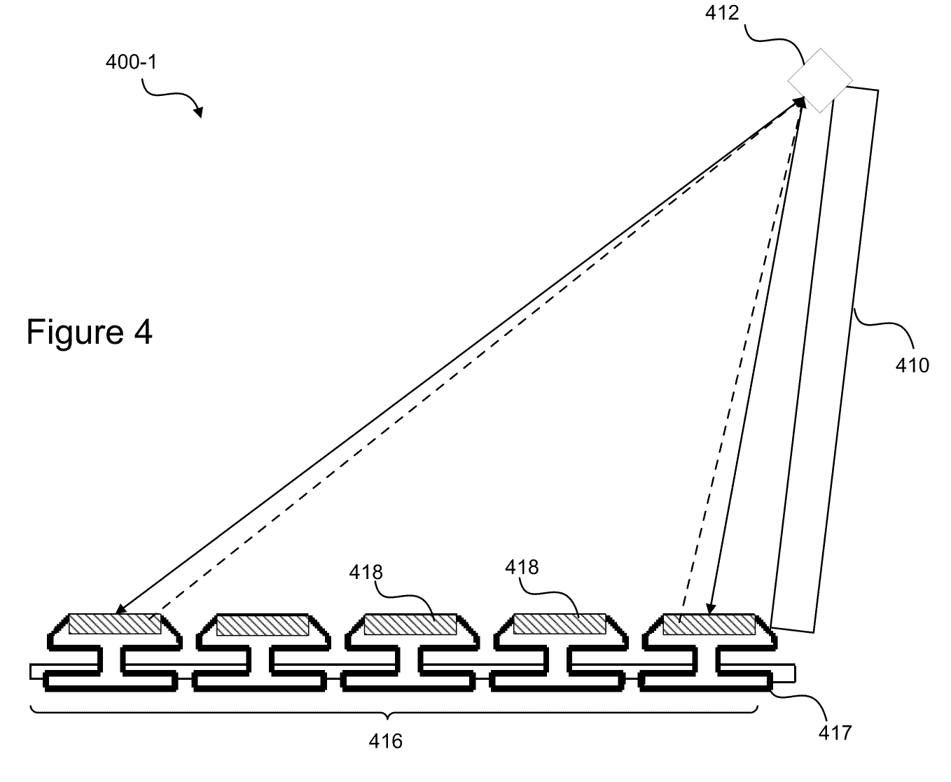

FIG. 4 shows an example of a device 400-1 configured to reflect light towards one or more sensors by using reflective keys of an input device. In this example, display 410 includes an optical assembly 412 configured to emit light towards an input device, in this example keyboard 416. Keys 417 are shown in an exaggerated view, but it will be understood that this is for explanation only and key size and number can vary. As shown at 418, the keys 417 comprise retroreflective material configured to reflect light into the space above keyboard 416 and between keyboard 416 and display 410. The reflective material 418 can comprise a coating on the surface of keys 417, a material included in the body of the keys 417, and/or may be integrated in any other suitable manner.

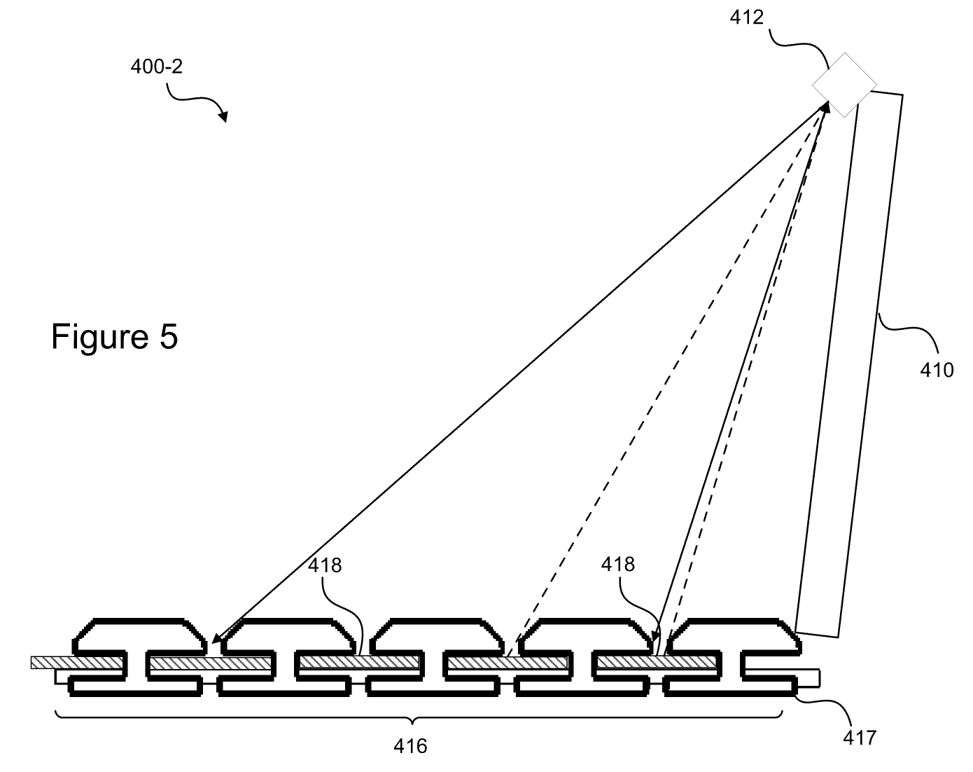

FIG. 5 shows an example of a device 400-2 similar to device 400-1. However, device 400-2 is configured to reflect light towards one or more sensors of assembly 412 by using reflective material 418 visible between keys 417. For instance, a retroreflective layer can be included on a substrate or board that supports keys 417 so that the material is visible between gaps in the keys at all times and/or through spaces that occur when one or more keys 417 are pressed.

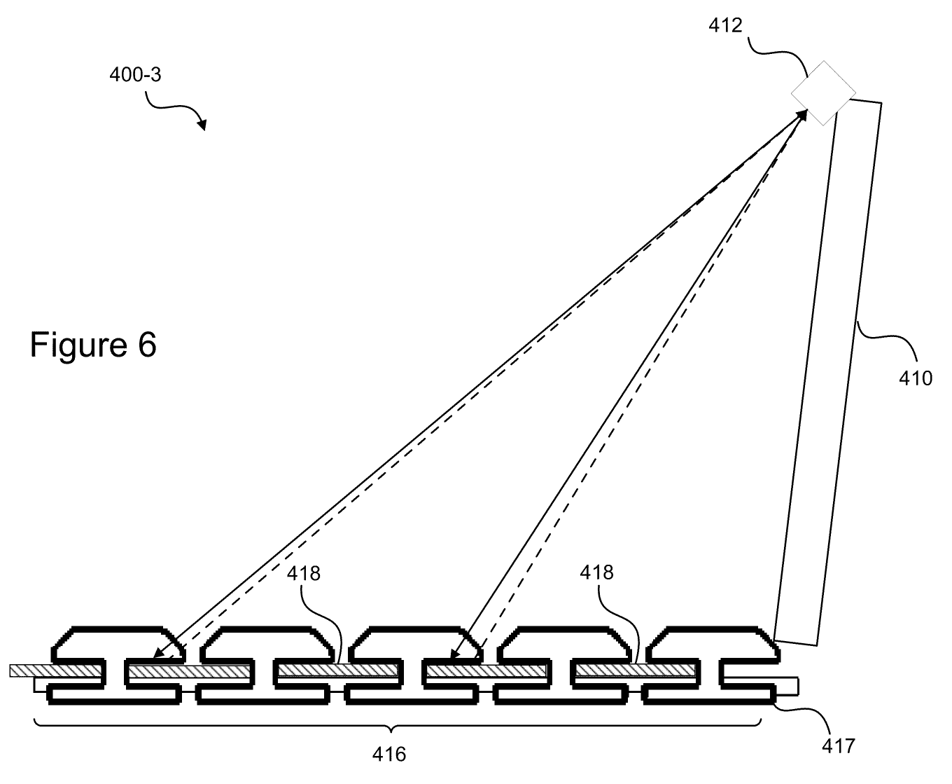

FIG. 6 shows an example of a device 400-3 configured to reflect light towards one or more sensors of assembly 412 by using reflective material visible 418 through keys of an input device. For example, keys 417 may comprise material that is transparent or semi-transparent at wavelengths detected by optical assembly 412. As an example, keys 417 may comprise material that can pass infrared light detected by assembly 412. As another example, keys 417 may comprise openings that allow light to pass through.

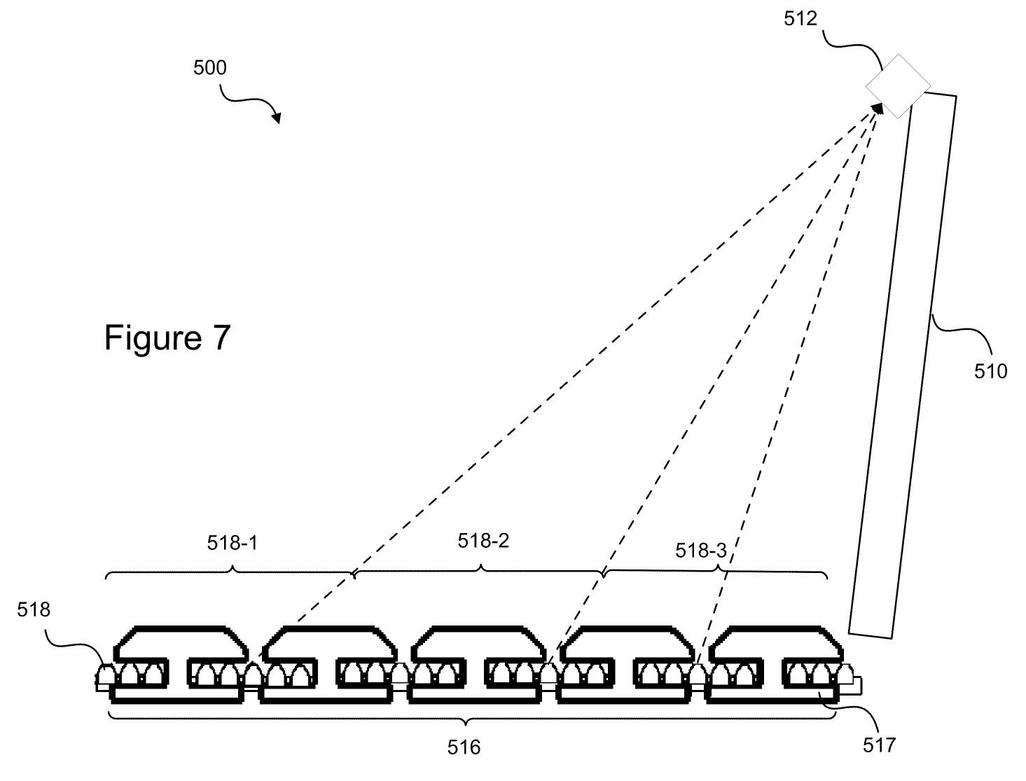

FIG. 7 shows an example of a device 500 configured to direct light into a space above an input device and towards one or more sensors by providing illumination through and/or between keys of an input device. Accordingly, direct light can be used instead of or in addition to light that is emitted from an optical assembly and then retroreflected.

In this example, display 510 again features an optical assembly 512 comprising one or more sensors. The input device comprises a keyboard 516 featuring keys 517. In this example, an array of lighting devices 518 is included in the keyboard. For instance, lighting devices 518 may be configured similar to back-lit keyboards. As an example, a plurality of infrared light emitting diodes can be included in addition to light sources of a conventional backlight assembly. Light from devices 518 may be visible through gaps between keys 517, and/or may be visible through keys 517 via openings and/or may be passed via material in the body of keys 517 that is transparent at the wavelength(s) used by the sensor of optical assembly 512.

In some embodiments, different patterns of light can be emitted into the space above the input device. In the example of FIG. 7, different areas 518-1, 518-2, and 518-3 can be illuminated at different times. Illumination of different areas can be used to enhance detection of objects in the field of view of the optical assembly. For instance, a “line scanning” type of illumination pattern can be used to aid in determining movement/position in a plane as well as distance from the camera to the plane. Although shown in conjunction with sources 518, similar techniques can be used with retroreflected light. For instance, light emitters of an optical assembly can be configured to illuminate different portions of a keyboard/retroreflective member in a pattern or sequence to achieve a similar effect.

In several of the examples herein, one or more sensors are included on or near a display, with light reflected from and/or directed from an input device. It will be understood that the same principles may be applied to systems in which the sensor(s) are positioned at the input device, with light reflected from a material on or near the display. Additionally, various combinations can be used. For example, light may be directed into an area above an input device using light sources in the input device and using light sources directing light from a display toward reflective material included in the input device.

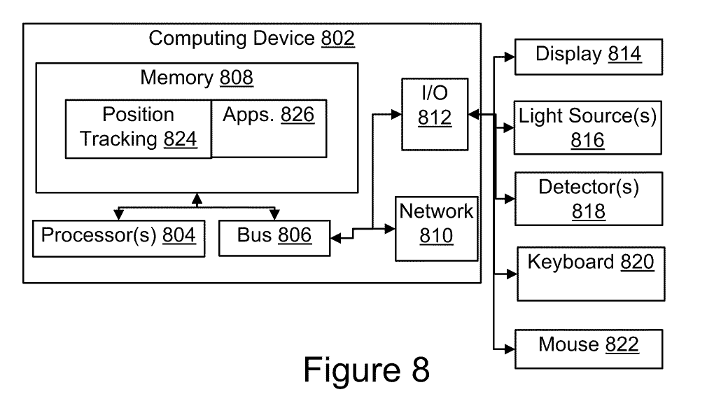

FIG. 8 is a block diagram showing illustrative hardware of a computing system 800 configured to determine user input based on interference with light in a space above an input device. In this example, a computing device 802 comprises one or more processors 804, a tangible, non-transitory computer-readable medium (memory 808), a networking component 810, and several I/O components linked to processor 804 via I/O interface(s) 812 and bus 806.

For example, memory 808 may comprise RAM, ROM, or other memory accessible by processor 804. I/O interface 812 can comprise a graphics interface (e.g., VGA, HDMI) to which display 814 is connected, along with a USB or other interface to which light source or sources 816, detector(s) 818, keyboard 820, and mouse 822 are connected. Other devices may, of course, be connected to device 802. Networking component 810 may comprise an interface for communicating via wired or wireless communication, such as via Ethernet, IEEE 802.11 (Wi-Fi), 802.16 (Wi-Max), Bluetooth, infrared, and the like. As another example, networking component 810 may allow for communication over communication networks, such as CDMA, GSM, UMTS, or other cellular communication networks. Some or all of the I/O devices may be integrated into a single unit as device 802.

Computing device 802 is configured by program components embodied in the memory to provide one or more position or motion tracking components 824 and one or more applications 826. For instance, program component 824 may configured the processor to control light source(s) 816, sample data from detector(s) 818, and use data regarding detected patterns of light to track a position of an object, identify motion of an object, or otherwise recognize input in accordance with the present subject matter. For example, a series of movements may be recognized as a gesture, with the recognition of the gesture provided to an application 826 (and/or an operating system) for handling as an input event (e.g., treatment as a mouse click event). Program components 824 may represent a device driver or may be built into an operating system.

In another embodiment, light source(s) 816 and detector(s) 818 utilize a processor and memory to control the light sources, read sensor data, and provide output identifying object position/motion to computing system 802. For example, light source(s) 816 and sensor(s) 818 may be interfaced to a digital signal processor (DSP) running a control program, with the DSP connected via I/O interface 812 (e.g., by a USB connection).

Various computation techniques can be used in order to identify user input based on interference with light. As an example, the “visual hull” technique can be utilized. Generally, the shape of a 3D object can be reconstructed from its shadow formed from illumination in two or more directions. The technique is most successful when an object is reasonably simple and that the illumination and sensors are arranged so that the shadow projects distinctive geometrical features of the object. Details on the visual hull technique can be found in Laurentini, “The visual hull concept for silhouette-based image understanding,” IEEE Transactions on Pattern Analysis and Machine Intelligence, vol. 16, 150-162 (1994).

However, the use of the visual hull technique for gesture recognition does not require absolute fidelity in recognizing shapes. Instead, for recognition of input gestures, the position recognition system can have access to a model for the shape to be identified. For instance, the system can use the visual hull technique (or another recognition technique) to identify one of a fixed library of shapes in the field of view. Then, the system can determine the position by triangulation and determine the movement by triangulation from a sequence of frames of the sensor. As an example, the fixed library of gestures can include a pair of fingers moving across/in front of the screen. Detection and identification of the pair of fingers shape plus movement can be correlated to a scrolling gesture.

FIG. 9 is a diagram showing a generalized view of use of the visual hull technique in identifying an input gesture. Planes 902 and 904 show respective shadows S′ and S″. As can be seen in FIG. 9, by projecting from point V′ through shadow S′, and by projecting from point V″ through shadow S″, hulls of objects 906 and 908 can be discerned. Planes 902 and 904 may, for example, correspond to the field of view of the same camera under different lighting conditions or may correspond to fields of view of different cameras.

For instance, returning to FIG. 1, plane 902 may correspond to the detected retroreflected light in the field of view of sensor 112 that is observed when emitter 114 on the left side of the screen is illuminated, while plane 904 may correspond what is observed in the field of view when the emitter 114 on the right side of the screen is illuminated. Of course, a combination of different lighting conditions/cameras can be used as well. Different illumination may be provided by modulation, use of different frequencies of light, and/or any other techniques.

Different gestures can be recognized based on matching a detected hull to a shape from a gesture library. For example, initially a single shape 906 may be detected based on shadows cast in the retroreflected light. When a user extends a finger/thumb, then the combination of shapes 906 and 908 may be recognized based on changes in the shadows.

Position and/or movement of an object during a gesture can be determined using triangulation techniques. Exemplary triangulation calculations are noted below, but the triangulation determination should be within the ability of one of ordinary skill in the art upon review of the present disclosure. For this triangulation example:

Intersection=Triangulation(m0,m1)

Where mo and m1 are obtained from the camera images and are the slopes of the lines from camera 0 and camera 1 respectively to the intersection measured with respect to the x axis; i.e. the line joining the cameras.

Given a touch screen with coordinates:
[0 1 0 yₘₐₓ]
   with camera0 at [0 0] and pointer angle m₀, camera 1 at [1,0] gives angle at m₁

Camera 0 intercept is at the origin, so therefore

y₀=m₀*x₀

Camera 1 is at [1,0], so

y₁=m₁*x₁+c

0=m₁*1+c

c=−m₁

y₁=m₁*x₁−m₁

Accordingly, pointer intersection [x_m, y_m] is calculated from

$${m}_{0} * {x}_{m} = {m}_{1} * {x}_{m} - {m}_{1}$$

$${x}_{m} ( {m}_{0} - {m}_{1} ) = {m}_{1}$$

$${x}_{m} = \frac{{m}_{1}}{{m}_{0} - {m}_{1}}$$

$${y}_{m} = {m}_{0} * {x}_{m}$$

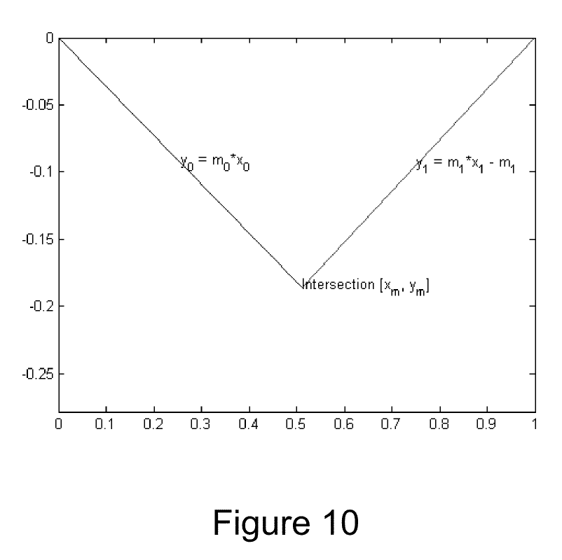

FIG. 10 is a chart showing a plot using exemplary triangulation method. The triangulation and position detection techniques noted herein are for purposes of example, and it will be understood that other shape recognition techniques can be used.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A position detection system, comprising:
a display device;
an input device; and
an optical assembly positioned adjacent to the display device, the optical assembly comprising an image sensor configured to detect light in a space between the display device and the input device,
wherein at least one of the imaging assembly and the input device is configured to direct energy into the space between the display device and the input device.

2. The system set forth in claim 1, further comprising:
a processing device, the processing device configured to use the imaging sensor to determine when an object is in the field of view based on detecting interference with light in the space between the display device and the input device.

3. The system set forth in claim 2, wherein the processing device is configured to identify a position of the object based on a reduction of energy reflected from the input device.

4. The system set forth in claim 3, wherein the processing device is interfaced to a computing system, the computing system configured to identify an input gesture based on tracking the position of the object over a time interval.

5. The system set forth in claim 1, wherein a retro-reflective member is included in an input device positioned in the field of view and the optical assembly comprises an energy emitter.

6. The system set forth in claim 5, wherein the input device comprises a keyboard.

7. The system set forth in claim 6, wherein the retro-reflective member comprises a retro-reflective material embedded in a surface of a plurality of keys of the keyboard.

8. The system set forth in claim 6, wherein the retro-reflective member comprises a retro-reflective material positioned below keys of the keyboard and visible at least through gaps between the keys.

9. The system set forth in claim 6, wherein the retro-reflective member comprises a retro-reflective material positioned below keys of the keyboard, the keys of the keyboard comprising a material that is at least partially transparent at a wavelength of energy emitted from the imaging assembly.

10. The system set forth in claim 6, wherein the keyboard comprises an energy emitter configured to emit energy into the space between the keyboard and the display device.

11. The system set forth in claim 1, wherein the display and retro-reflective member are comprised in a notebook computer, the imaging assembly mounted to the display and the retro-reflective member comprised in a keyboard of the notebook computer.

12. A position tracking method, comprising:
using an emitter positioned adjacent an imaging sensor, emitting light across a space and toward a retro-reflective member, the retro-reflective member comprised in or near an input device of a computing system;
detecting, using the imaging sensor, light reflected back toward the sensor by the retro-reflective member; and
determining at least one of a position of an object in the space or movement of the object in the space based on interference by the object with at least one of light emitted toward the retro-reflective member or reflected back toward the sensor.

13. The method set forth in claim 12, wherein determining a position of the object is based on a reduction in light detected using the imaging sensor due to interruption of light reflected back toward the sensor by the object.

14. The method set forth in claim 12, further comprising:
identifying a gesture based on determining the position of the object over a time interval.

15. The method set forth in claim 12, wherein the emitter and imaging sensor are positioned on a display device of a computing system configured to determine the position of the object.

16. The method set forth in claim 15, wherein the retro-reflective member comprises retro-reflective material included in a keyboard of the computing system.

17. The method set forth in claim 12, wherein the light comprises infrared light.

18. A storage medium embodying program code executable by a computing device, the program code comprising:
program code that configures the computing device to read data from an imaging sensor;
program code that configures the computing device to determine, based on the data, a level of reflected light detected from a retro-reflective member; and
program code that configures the computing device to identify, based on the level of reflected light, if an object has interfered with the light and, if, so, a position of the object.

19. The storage medium set forth in claim 18, further comprising:
program code that configures the computing device to drive a light source to emit light across a space towards the retro-reflective member.

20. The storage medium set forth in claim 18, wherein the program code that configures the computing device to identify the position of the object configures the computing device to determine a position of at least two objects.
